(19) United States
(12) Patent Application Publication
(10) Pub. No.: US 2007/0165033 A1
(43) Pub. Date: Jul. 19, 2007

(54) Image generating method

(75) Inventors: Fumitoshi Matsuno, Kanagawa (JP); Masahiko Inami, Tokyo (JP); Naoji Shiroma, Ibaraki (JP)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Campus Create Co., Ltd., Tokyo (JP)

(21) Appl. No.: 10/587,016

(22) PCT Filed: Jan. 19, 2005
(86) PCT No.: PCT/JP05/00582

§ 371 Date: Jul. 21, 2006

(30) Foreign Application Priority Data
Jan. 21, 2004 (JP) 2004-013689

(51) Int. Cl. G06T 15/70

(52) U.S. Cl. 345/475

(57) ABSTRACT

This invention provides an image generating method that simplifies moving body operation. This method includes the following steps. (1) a step of receiving environment information (for example, environment images) using one or a plurality of space measurement sensors (for example, a camera) attached to a moving body; (2) a step of receiving time when the environment information is received, and parameter of the space measurement sensor itself (for example, position and attitude of a camera) at the time; (3) a step of saving history information representing the environment information, the time, and the parameters; (4) a step of receiving designation for virtual observation point; and (5) a step of generating virtual environment image seen from the virtual observation point based on the saved history information.

### TECHNICAL FIELD

The present invention relates to an image generating method.

### BACKGROUND ART

Conventionally, operation of a moving body while watching an image acquired by a camera attached to the moving body have been carried out. A moving body is, for example, a self-propelled robot in a remote place. When the moving body is in a remote place, an image is transmitted to an operator via a communications network.

However, an image acquired by the camera of the moving body often does not contain much environment information of the area around the moving body. This is because if viewing angle is widened while maintaining resolution, the amount of image information is increased, and the load on communication path and information processing equipment increases. Appropriately operating a moving body while looking at an image with a narrow viewing angle is considerably difficult in many cases.

On the other hand, it is possible to consider a method where a separate external camera is arranged externally to the moving body, and environment images are acquired using this external camera. However, using both images of the moving body camera and images of the external camera will inevitably lead to an increase in the amount of image information. If the amount of image information is increased, it becomes necessary to set the image resolution and frame rate low to prevent time delay in communication and information processing. If this is done, there will be a degradation in image quality. Conversely, if image quality is maintained, there is a time delay until the image is provided, and as a result moving body operations in real time are difficult. Of course, it is possible that these problems would be alleviated by increasing the speed of the communication path and image information processing devices, and compression of the information amount, but in any case increase in the amount of acquired image information causes an increase in load on the systems containing the communication path.

### DISCLOSURE OF THE INVENTION

The present invention has been conceived in view of the above-described situation. An object of the present invention is to provide an image generating method for simplifying operation of a moving body.

An image generating method of the present inventions comprises steps of:

(1) a step of receiving environment information from one or a plurality of space measurement sensors attached to a moving body;

(2) a step of receiving time when the environment information is received, and parameter of the space measurement sensor itself at the time;

(3) a step of saving history information representing the environment information, the time, and the parameter;

(4) a step of receiving designation for virtual observation point; and

(5) a step of generating virtual environment image seen from the virtual observation point based on the saved history information.

This image generating method can also include the steps of:

(6) a step of generating image of the moving body itself seen from the virtual observation point based parameter of the moving body itself.

(7) a step of generating a composite image including the image of the moving body itself and the virtual environment image, using the virtual environment image and the image of the moving body itself

It is possible for the environment information to be a plurality of still pictures, for example, or a moving picture.

It is possible for the parameter of the moving body itself in step (6) to be for “any time point between a time point when a virtual observation point is designated, or close to that time point, to a time point when a generated composite image is presented”.

The moving body can also be capable of propelling itself.

The virtual observation point can exist at a position looking at the environment around the moving body and/or the environment around a point the operator wants to see.

It is also possible for the virtual observation point to exist at a position looking at the moving body from the rear.

The “parameter of the space measurement sensor itself” in step (2) include, for example, “position and attitude of space measurement sensor itself” and/or “data, matrix or table representing a relationship between data space acquired by the space sensor itself and real space”.

The “generating based on history information” in step (5) is, for example, “selection of any image comprised in the environmental information based on closeness of position of the space measurement sensor itself at the time the environmental information is acquired, and the virtual observation point”.

The “generation based on history information” in step (5) is “new generation based on history information”.

The virtual environment image is, for example, a still image.

The image of the moving body itself contained in the composite image in step (7) can be a transparent, semi-transparent or wireframe image.

It is also possible to include position of the moving body in the parameter of the moving body itself.

It is also possible to further include attitude of the moving body in the parameter of the moving body itself.

A presentation method of the present invention presents a composite image generated using any of the above-described generation methods.

An image generating system of the present invention is provided with a moving body, a control section and an information acquisition section. The moving body is provided with a space measurement sensor for acquiring environmental information. The control section carries out the following functions.

(a) a function of saving history information representing the environmental information, the time when the environmental information was acquired, and parameter of the space measurement sensor itself at the time the environmental information was acquired;

(b) a function of receiving information for designated virtual observation point; and

(c) a function of generating virtual environment image seen from the virtual observation point based on the saved history information.

The image generating system can also further comprise an information acquisition section. The information acquisition section is for acquiring parameter of the moving body itself. In this case, the control section further carries out the following functions:

(d) a function of generating image of the moving body itself seen from the virtual observation point based on parameter of the moving body itself;

(e) a function of generating a composite image including an image of the moving body and the virtual environment image, using the virtual environment image and the image of the moving body itself;

A computer program of the present invention causes a computer to execute the steps of any of the above-described methods.

A computer program of the present invention can also cause a computer to execute the functions of the control section of the above-described system.

Data relating to the present invention includes information representing the virtual environment image generated using any of the above-described generating methods or the composite image.

A storage medium of the present invention stores this data.

According to the present invention, it is possible to provide an image generating method that simplifies moving body operation.

### BRIEF DESCRIPTION OF THE DRAWINGS

FIG. 1 is a block diagram showing the outline of an image generating system of one embodiment of the present invention.

FIG. 2 is a flowchart for describing an image generating method of one embodiment of the present invention.

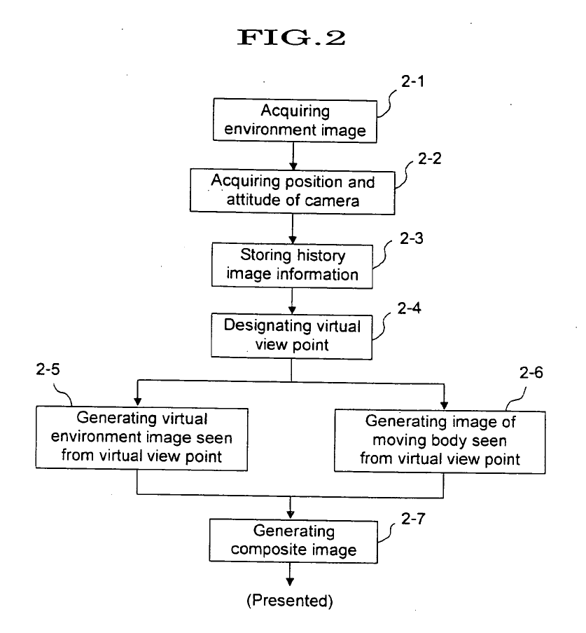

FIG. 3 is an explanatory drawing showing an example of images used in the image generating method of one embodiment of the present invention.

FIG. 4 is an explanatory drawing showing an example of images used in the image generating method of an example of the present invention.

FIG. 5 is an explanatory drawing showing an example of images used in the image generating method of an example of the present invention.

FIG. 6 is an explanatory drawing showing an example of images used in the image generating method of an example of the present invention.

### BEST MODE FOR CARRYING OUT THE INVENTION

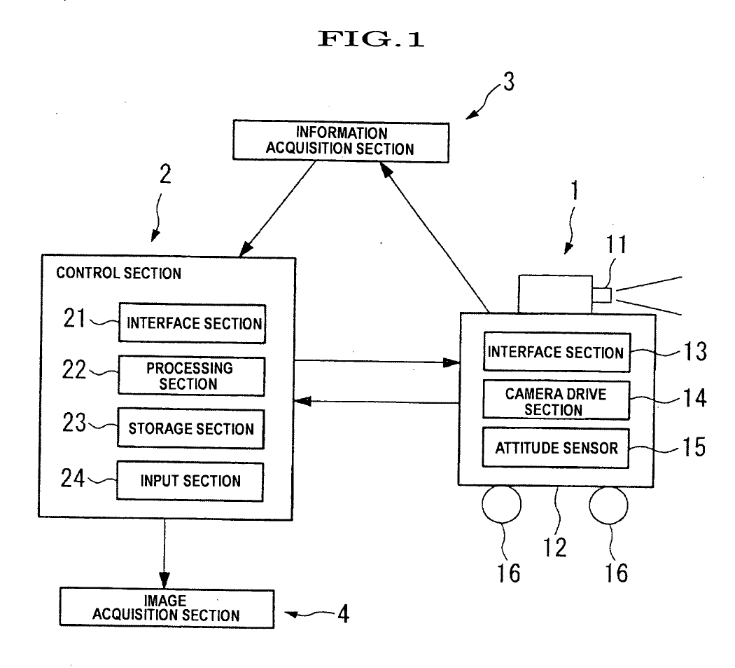

An image generating method of one embodiment of the present invention will be described with reference to the attached drawings. First of all, the structure of an image generating system used in this embodiment will be described based on FIG. 1.

### System Description

This system comprises a moving body 1, a control section 2, an information acquisition section 3, and an image presentation section 4 as main elements.

The moving body 1 is, for example, a self-propelled remote controlled robot. The moving body 1 is provided with a camera 11(corresponding to the space measurement sensor of the present invention), a body 12, an interface section 13, a camera drive section 14, an attitude sensor 15, and a body drive section 16.

The camera 11 is attached to the body 12, and acquires environment images seen from the moving body 1 (being an external image, corresponding to environmental information of the present invention). Environment images acquired by the camera 11 are sent via the interface section 13 to the control section 2. The camera 11 in this embodiment acquires still pictures, but it can also acquire moving pictures. Further, with this embodiment the camera 11 generates time information for the time each image is acquired (time stamp). This time information is also sent to the control section 2 via the interface section 13. It is possible for generation of this time information to be carried out by a section other than the camera 11.

As the camera 11, as well as a normal visible light camera it is possible to use various types of camera such as an infra-red camera, an ultra-violet camera, an ultrasonic camera etc. As space measurement sensors besides the camera, there are, for example, a radar range finder and an optical range finder. In other words, as a space measurement sensor any device can be used as long as it is capable of acquiring two-dimensional or three-dimensional (it is also possible to be capable of acquiring a further dimension such as time) information (namely, environment information) on an subject (external environment). With a radar range finder or an optical range finder, it is possible to easily acquire three dimensional position information for a subject within the environment. In these cases also, normally a time stamp is generated by the space measurement sensor and sent to the control section 2.

The interface section 13 is connected to a communication network circuit (not shown) such as the Internet. The interface section 13 has functions of supplying information acquired by the moving body 1 to the outside, or receiving information (for example, control signals) from the outside at the moving body 1. As the communication network circuit, it is possible to use any suitable means such as a LAN or telephone line, etc., besides the Internet. That is, there is no particular restriction on the protocol, circuits and nodes used in the network circuit. It is also possible to have a circuit switching method or packet method as the communication method of the network circuit.

The camera drive section 14 varies position (position in space or position on a horizontal plane) and attitude (viewing direction or optical axis direction of the camera) of the camera 11. The camera drive section 14 can vary position and attitude of the camera 11 using commands from the control section 2. This type of camera drive section 14 can be easily manufactured using a control motor, for example, and so any further description will be omitted.

The attitude sensor 15 detects attitude of the camera 11. This attitude information (for example, optical axis angle, viewing angle, attitude information acquisition time etc.) is sent via the interface section 13 to the control section 2. Since this type of attitude sensor 15 itself can be easily made, any further description will be omitted.

The body drive section 16 causes self-propulsion of the moving body 1 using commands from the control section 2. The body drive section 16 comprises, for example, wheels (including caterpillar tracks) attached to a lower part of the body 12 and a drive motor (not shown) for driving the wheels.

The control section 2 comprises an interface section 21, processing section 22, storage section 23 and input section 24. The interface section 21 is connected to a communication network circuit (not shown), similarly to the interface section 13. The interface section 21 has functions of supplying information from the control section 2 to the outside via the communication network circuit, or receiving information from the outside at the control section 2. For example, the interface section 21 acquired various information sent from the interface section 13 of the moving body 1 to the control section 2, or sends control signals to the interface section 13.

The processing section 22 realizes the following functions (a)-(e) in accordance with a program stored in the storage section 23. The processing section 22 is a CPU, for example. The following functions (a)-(e) will be described in detail later in a description of the image generating method.

(a) a function of saving history information representing environment images, the time when the environment images were acquired, and position and attitude of the camera at the time the environmental images were acquired (corresponding to the parameters);

(b) a function of receiving information for designated virtual observation point; and

(c) a function of generating virtual environment image seen from virtual observation point based on saved history information.

(d) a function of generating image of the moving body itself seen from virtual observation point based on position and attitude of the moving body itself; and

(e) a function of generating a composite image containing an image of the moving body and the virtual environment image, using the virtual environment image and the image of the moving body itself.

The storage section 23 is a section for storing computer programs for causing operation of the control section 2 and the other functional elements, three dimensional model information of the moving body 1, and history information (such as position and attitude information of the moving body 1 and camera 11, or information acquisition time for these items of information, etc.). The storage section 23 is an arbitrary storage medium such as, for example, a semiconductor memory or hard disk.

The input section 24 receives input (for example, input of virtual observation point information) from the operator to the control section.

The information acquisition section 3 acquires position and attitude (orientation) of the moving body itself 1. The position and attitude of the moving body 1 of this embodiment correspond to “parameters of the moving body itself” of the present invention. It is also possible to use parameters such as speed, acceleration, angular velocity and angular acceleration of the moving body as “parameters of the moving body itself”, as well as the position and attitude of the moving body 1. This is because it is possible to detect positional variation of the moving body using these parameters also.

In obtaining the position and attitude of the moving body 1, it is possible to use already known three dimensional own position estimation methods such as equipment using, for example, a gyro, an accelerometer, wheel rotation angular velocity meter, GPS, ultrasonic sensors etc. These types of method themselves can use already known technologies, and so detailed description thereof is omitted.

Further, the information acquisition section 3 acquires the time when position and attitude of the moving body 1 are acquired. However, it is also possible to have an implementation that does not acquire time information.

Position of the camera 11 can be acquired as position of the moving body 1 if the camera 11 is fixed to the moving body 1. With this embodiment, position of the body 1 is acquired using the information acquisition section 3, and position of the camera 11 fixed to the body 1 is calculated from the position of the body 1. Conversely, it is also possible to acquire position of the camera 11 to calculate position of the moving body 1.

The information acquisition section 3 can be separate from the control section 2 and moving body 1, or can be integrated with the control section 2 or moving body 1. It is also possible for the information acquisition section 3 and the attitude sensor 15 to exist in a single integrated mechanism or device.

The image presentation section 4 is for receiving and presenting an image (composite image) generated by operation of the control section 2. The image presentation section there is, for example, a display or a printer.

Incidentally, it will be usual for the parameters of the space measurement sensor itself in the present invention to be position and attitude if the sensor of the sensor is a camera. However, it is also possible for the parameters, in addition to or instead of position and attitude, to be data, a matrix or a table representing a relationship between data space and actual space. This “data, matrix or table” is calculated using elements such as “focal distance of camera, coordinates of image center, scale factor of vertical and horizontal direction of image surface, shear coefficient or lens aberration” etc. Also, if the space sensor is a range-finder, the parameters of the range-finder itself are, for example, the position, attitude, depth, resolution and angle of view (data acquisition range) of the range-finder.

### Description of Image Generation Method

Next, the image generating method used in the system of this embodiment will be described. First of all, it is assumed that position and attitude of the moving body 1 are kept on a normal track using the information acquisition section 3. Obviously it is also possible for the information acquisition section to intermittently or continuously acquire this information in a temporal or spatial manner. The acquired information is stored in the storage section 23 of the control section 2. With this embodiment, this information is stored, together with the acquisition time of that information, as data in an absolute coordinate system (coordinate system that is not relative to the moving body, also called a world coordinate system).

(Step 2-1)

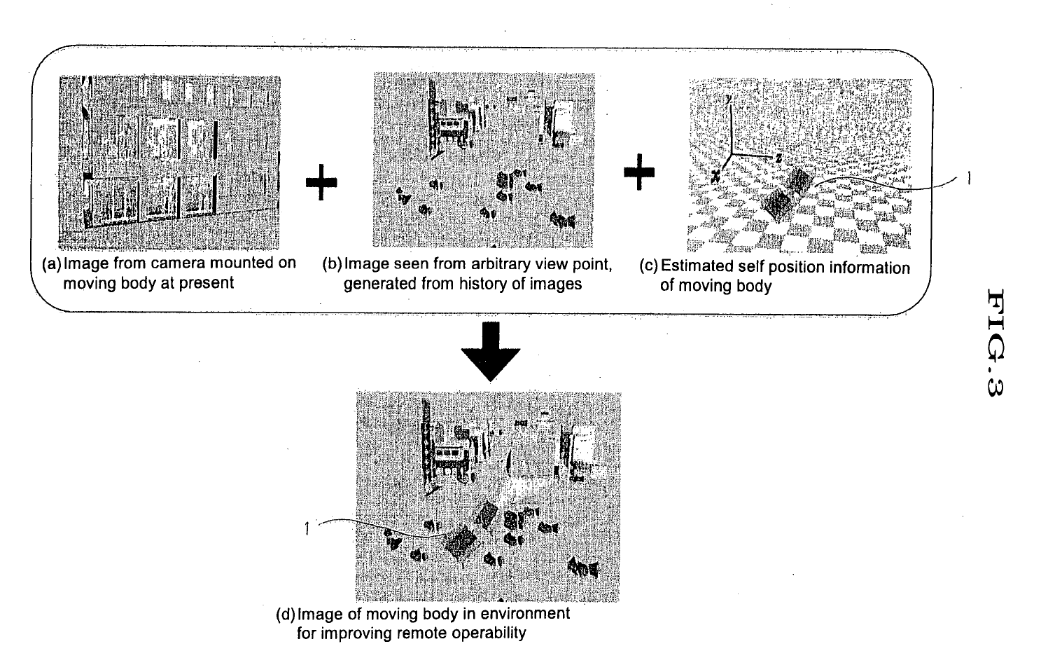

First of all, environment images (refer to FIG. 3a) are acquired using the camera 11 attached to the moving body 1. The time at which the environment images were acquired (time stamp) is also acquired by the camera 11. A period for acquiring environment images can be set in accordance with conditions such as moving speed of the moving body 1, angle of view of the camera 11, channel capacity of the communication path etc. For example, it is possible to perform setting so that still images are acquired every 3 seconds as environment images. The acquired images and time information are sent to the control section 2. The control section 2 stored these items of information in the storage section 23. After that, each item of information sent to the control section 2 is temporarily stored in the storage section 23. The environment images are normally still pictures, but they can also be moving pictures.

(Step 2-2)

Further, the information acquisition section 3 acquires information relating to position and attitude of the moving body 1, at the point in time the environment image was acquired, and sends this information to the control section 2. On the other hand, the attitude sensor 15 of the moving body 1 acquires information relating to attitude of the camera 11 and sends this information to the control section 2. In more detail, the information acquisition section 3 sends attitude data of the camera 11 to the control section 2 correlated to each environment image acquired at that point in time.

With this embodiment, position data of the camera 11 at the point in time the environment image was acquired is calculated from position information of the moving body 1 (position at the image acquisition time) and the potion information is acquired by the information acquisition section 3. The position of the moving body 1 at the point in time the environment image is acquired can be detected using the time stamp, or can be detected using a method that correlates data acquired for each timeslot.

(Step 2-3)

Next, environment images and time information, and information representing position and attitude of the camera 11 at the point in time the environment images and time information are acquired (in this embodiment these items of information are collectively referred to as history information), are stored in the storage section 23 by the control section 2. These items of information can be stored at the same time, or can be stored at different times. Specifically, data for the environment images and position and attitude data of the camera 11 are correlated in time and stored in a table. That is, these items of data can be searched with time information or position information as a retrieval key. Also, here the information representing position and attitude does not have to be position data and attitude data. For example, it is possible to have data (or data sets) that can calculate these data items through computation.

(Step 2-4)

Next, virtual observation points are designated. This designation is normally carried out as required by the operator, using the input section 24 of the control section 2. Also, position of the virtual observation points is preferably specified using absolute coordinates, but it is also possible to designate using a relative position from a current virtual observation point. The positions of the virtual observation points are set, for example to view an image containing the moving body 1 from the rear of the moving body 1. It is also possible for positions of the virtual observation points to be for viewing the environment around a place the operator wants to see, not including the moving body 1.

(Step 2-5)

Next, virtual environment images seen from virtual observation points (refer to FIG. 3b) are generated based on saved history information. Virtual environment images are normally still pictures, but it is also possible to make them moving pictures. An example of a method of generating virtual environment images will be described in the following.

### When Obtaining Images Close Together in Space

In this case, from among images (environment images) contained in history information, an image taken close to the virtual observation point is selected. What distance is determined as close can be appropriately set. For example, this determination can be carried out using information on position and attitude (angle of view) at the time the image was taken, or what the focal distance is. In short, it is preferable to set so that it is possible to select an image that it is easy for the operator to see and understand. In the above-described manner, the position and attitude of the camera 11 at the time past images were taken are stored.

### When Obtaining Images Far Apart in Space

In this case also, it is possible to use images actually taken by a camera. However, it is preferable to newly generate images from the virtual observation points based on images actually obtained, in order to improve image quality. It is possible to use existing computer vision technology in this type of image generating method. With this embodiment, a method for generating arbitrary virtual images in an image base with real time considerations and without creating an environment model will be described. One example of an algorithm for this case is shown in the following.

(a) Select a plurality of images for the vicinity of the virtual observation pints from history information. Determination of this “vicinity” can be carried out in a similar way the “case of obtaining images close together in space”.

(b) Obtain corresponding point between two images among the plurality of images.

(c) Perform propagation of corresponding points between images so as to obtain close corresponding points across the images.

(d) Obtain trifocal tensors between images based on corresponding points.

(e) Using the trifocal tensors, all pixels obtained for correspondence in the two images are mapped to virtual environment images seen from an arbitrary observation point. In this way, it is possible to generate virtual environment images.

(f) More preferable, the operation is also carried out for other images besides those in the vicinity of the virtual observation points. If this is done, by using these images also it is possible to generate virtual environment images, which can be more precise, over a wide field of view.

Of course, it is also possible to have a method where a three dimensional environment model is temporarily generated from environment images, and virtual environment images looking from an arbitrary observation point are generated based on this model. However, in this case, in order to create the model there is a problem that it is necessary to spend time acquiring a large number of environment images and performing lengthy calculations.

(Step 2-6)

Next, an image of the moving body 1 looking from the virtual observation point is generated based on position and attitude of the moving body 1. Information on the position and attitude of the moving body 1 is acquired by constantly tracking using the information acquisition section 3 (refer to FIG. 3(c)), which means that it is possible to understand information position and attitude of the moving body 1 from this information. This position and attitude information is simply coordinate data, and so load on the communication path is small compared to image data. Based on this position and attitude information, an image of the moving body 1 looking from the virtual observation point in an absolute coordinate system is generated.

The image of the moving body 1 generated here is normally an image of the moving body 1 at the current observation point, but it can also be an image of the moving body 1 at a future position which can be generated by using estimation, or an image of the moving body 1 at a particular past point in time.

(Step 2-7)

It is possible to generate a composite image containing an image of the moving body 1 and a virtual environment image using the virtual environment image and moving body 1 image generated in this way. This image is presented at the image presentation section as required by the operator. It is also possible to store the composite image data in a suitable storage medium (for example, FD, CD, MO, HD etc.).

If the position or attitude of the moving body is varied, position and attitude data of the moving body after change is acquired by using the information acquisition section 3, the data is sent to the storage section 23 of the control section 2 together with acquisition time, and data update is performed. Also, an environment image for the position after movement is acquired by the camera 11 together with time information (time stamp). After that, operations from step 2-2 onwards are repeated.

With the method of this embodiment, in this manner it is possible to generate and present a virtual environment image including the moving body 1. In doing so, since it is possible to operate the moving body while looking at the moving body there is the advantage that it is possible to improve simplicity of operation.

Also, with this embodiment, since a virtual environment image looking from the virtual observation point is generated based on an environment image acquired in the past, it is not necessary to externally provide a camera for environment image acquisition, and there is the advantage that it is possible to miniaturize the device and reduce lost.

Also, when a camera is externally provided for environment image acquisition or the camera angle of view is made wide, since the data amount is increased, problems arise such as increase in load on the communication path, and frequently the frame rate is lowered. If that is the case, operation in real time becomes difficult. According to this embodiment, since a virtual environment image is generated using past images, there is the advantage that there is no impediment to real time operation even if there is a time delay in acquisition of image information. Further, if an algorithm for generating a virtual environment image without creating a three dimensional environment model from past images is used, the generation time of the virtual environment image is shortened which further improves real time nature of the operation

Further, with this embodiment, a delay in acquisition of the past images can be permitted, which means that it is possible to increase image resolution. There is therefore an advantage that it is possible to increase resolution of the obtained virtual environment image.

Incidentally, in the case where operation is made more difficult if a virtual environment image is used, it is possible to appropriately switch to an image from the camera 11 of the moving body 1 and present this to the operator.

### EXAMPLE 1

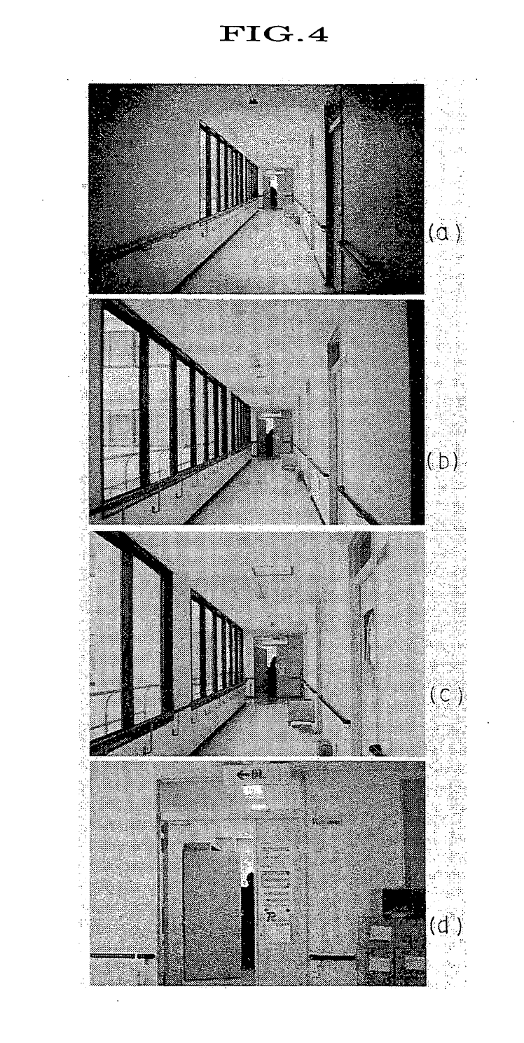

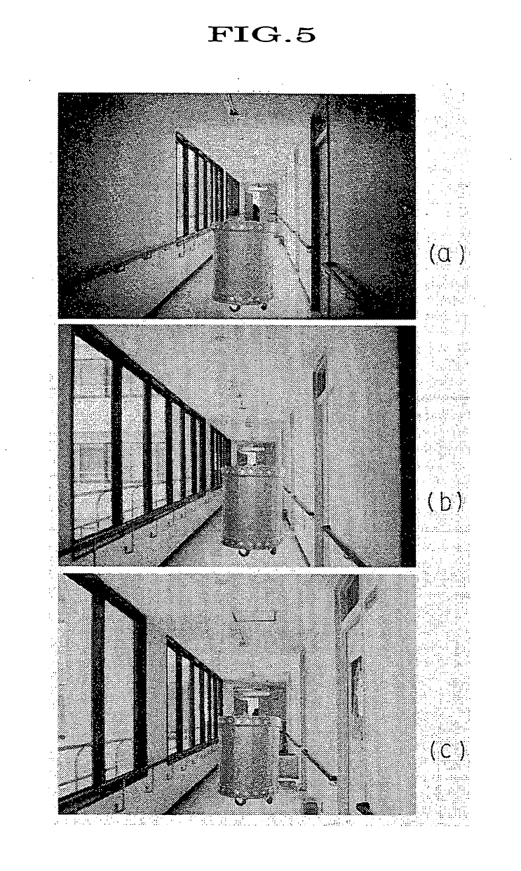

An example of the above-described method will be described based on FIG. 4-FIG. 6. Environmental images obtained continuously from the moving body 1 are as shown in FIG. 4(a) to FIG. 4(d), for example. Examples of virtual environment images generated from these images are shown in FIG. 5(a)-FIG. 5(c). FIG. 5(a) represents the image including the moving body 1 that sees the image of FIG. 4(b) by using camera 11 in real time. With FIG. 5(a), the image of FIG. 4(a), being an image further in the past than FIG. 4(b), is selected as a virtual environment image. Then, the image of the moving body 1 is composed in this virtual environment image. In this way, it is possible to generate and present an image looking at the moving body at a current position from behind (virtual observation point). As a result, it is possible to operate the moving body 1 while looking at the moving body 1 itself.

If the virtual observation point is also advanced accompanying movement of the moving body 1, it is possible to obtain the images shown in FIG. 5(b) and FIG. 5(c). These image generating methods are basically the same as those described above. With these images, virtual environment images are switched between FIG. 4(b) and FIG. 4(c) accompanying change in virtual observation point. The image of FIG. 4(d) is as image from the camera 11 of the moving body 1 contained in the image of FIG. 5(c).

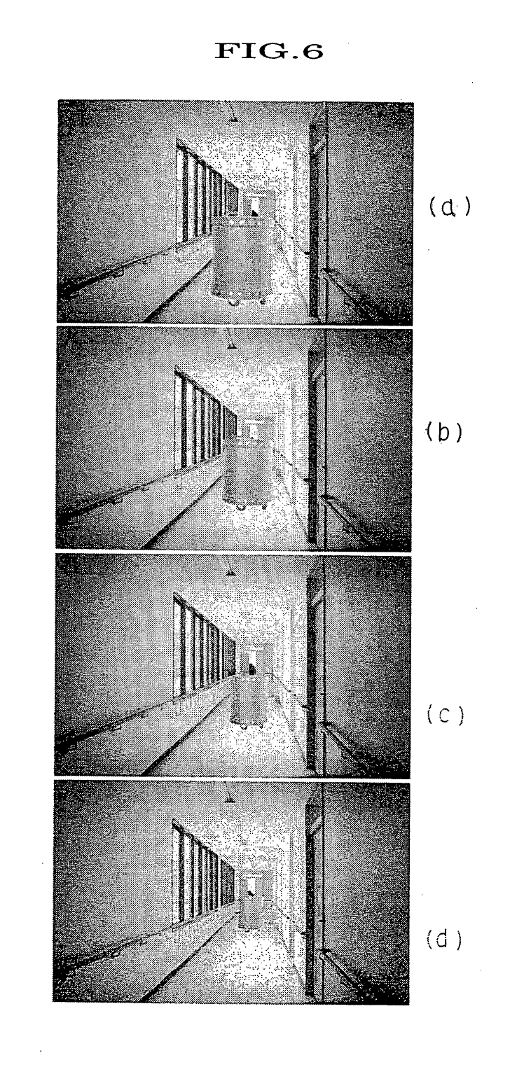

If the state of the communication path is bad, frame rate is lowered and there are no past images for generating environment images such as those of FIG. 5(b) and FIG. 5(c), it is possible to use an image in which the moving body 1 itself is moved. (refer to FIG. 6a to FIG. 6d). That is, the virtual observation point is fixed and the image of the moving body 1 is varied. With the method of this embodiment, since the position and attitude of the moving body 1 are understood, it is possible to generate an image of the moving body 1 corresponding to the position and attitude and compose it in the virtual environment image. Accordingly, the method of this embodiment has the advantage that operation of the moving body 1 in real time is made easy even when circuit speed is extremely low (for example, wireless signals from a moon probe robot to earth).

Incidentally, the image of the moving body 1 composed in the virtual environment image can be made semi-transparent. If this is done, it is possible to prevent the rear of the moving body 1 becoming a dead spot in the image from the virtual observation point, and it is possible to make operation of the moving body 1 much simpler. It is also possible to make the image of the moving body 1 transparent, and it is possible to obtain the same advantages also by alternately displaying with a non-transparent image. Instead of the semi-transparent image, it is possible to obtain the same advantages even if the moving body 1 is made a wireframe image. Further, by adding shadows of the moving body 1 inside the composite image it is also possible to further increase realism.

Further, vibration of the moving body 1 itself is normally directly related to vibration of the image with remote control making direct use of images from the camera 11 mounted on the moving body 1. An operator who performs operation of the moving body 1 using images that are vibrating in this way is performing operation of the moving body 1 using a vibrating image even though they do not themselves directly receive vibration, which may give a feeling of dizziness. With the method of the above-described embodiment, the moving body is subjected to vibration, and even if the acquired image itself of the camera 11 shakes it is possible to present the operator with a composite image where only the moving body 1 shakes within a fixed environment (virtual environment image). According to this method, therefore, it is possible to prevent the operator having this camera dizziness.

Realization of the above-described embodiment can be easily achieved by the operator using a computer A program to do this can be stored in any computer readable storage medium such as, for example, HD, FD, CD, MO etc.

Incidentally, the disclosure of the above-described embodiment is only a single example, and does not show essential structure in the present invention. The structure of each section of the embodiment is not limited to that described above as long as it is possible to achieve the object of the present invention.

For example, with the above-described embodiment, the moving body is a self-propelled robot, but this is not limiting and it is also possible to a moving body that is remote controlled or boarded by an operator (for example, a vehicle or helicopter). Further, the moving body is not limited to being self-propelled and can be driven by power from outside. Such example, include a tip end section of an endoscope in the field of endoscopic surgery, or the tip end section of a manipulator with a fixed base.

It is further possible for the moving body to be a person or an animal. For example, a camera is fitted to the person or animal itself, and in order to acquire images from behind the person or animal it is necessary to have a suitably large device. In this respect, it is possible to simply obtain an image from the rear of the person or animal itself by mounting a camera on the person etc, and generating a composite image. As a result, it is possible to exploit this method in sports training etc. It is also possible to confirm the condition of a person himself within an environment in real time (or using on-demand for data storage) even in activities where it is difficult for the person to take a picture from behind themselves (for example, skiing or surfing).

Also, in the case of using an ultrasonic camera as a space measurement sensor, by mounting this camera on an underwater moving body or an endoscope it becomes possible to acquire environment information such as underwater or inside a body, and to generate virtual environment images using this information.

Further, with this embodiment, a composite image having a moving body image has been presented, but it also possible to have a method or system for presenting virtual environment images without composing a moving body image. In this case also, since it is possible to present images over a wide field of view using history information, it is possible to improve simplicity of operation of the moving body 1.

Also, arrangement position of a space measurement sensor (for example, a camera) on the moving body is not limited to the tip of the moving body, and can be anywhere, such as a rear part, peripheral part etc.

Also, there is one moving body with the above-described embodiment, but it is also possible to have a plurality of moving bodies. In this case, the plurality of moving bodies have the structure of the above described moving body. In doing this, as long environment information and parameters of the space measurement sensors are stored in a unified format, it is possible to share information between a plurality of moving bodies, or between space measurement sensors of the same of different type.

In this way, it is possible to use environment information that has not been acquired by the moving body itself, for example, using information acquired by another moving body there is the advantage that it is possible to present virtual environment images seen through a rear side of an obstacle etc.

Incidentally, with respect to obstacles placed in a dead spot of the space measurement sensor at the current point in time, using environment images acquired in the past by a simple moving body itself, it is possible to present a virtual environment image containing this type of obstruction.

Presented virtual environment images or moving body images can also be generated by estimation. Estimation can be carried out, for example, based on speed of acceleration of the moving body 1. If this is done, since it is possible to present future conditions to the operator it becomes possible to further improve operability of the moving body.

Also, in step 2-6 of the above-described embodiment, an image of the moving body 1 looking from the virtual observation point is generated based on position and attitude of the moving body 1. However, in cases where attitude of the moving body 1 is not important, there may e cases where an image of the moving body 1 is generated based on position of the moving body 1.

Also, specific means for each section (including functional blocks) for realizing the above-described embodiment can use hardware (for example, a computer and sensors), computer software, a network, a combination of these or any other arbitrary means.

Further, it is also possible for each of the functional blocks to be combined, or be a single functional block or collected together with a device. It is also possible for a single functional block to be implemented using cooperation between a plurality of functional blocks or devices.

What is claimed is:

1. An image generating method comprising the following steps:
(1) a step of receiving environment information acquired by one or a plurality of space measurement sensor attached to a moving body;
(2) a step of receiving time when the environment information is received, and parameter of the space measurement sensor itself at the time;
(3) a step of saving history information representing the environment information, the time, and the parameter;
(4) a step of receiving designation for virtual observation point; and
(5) a step of generating virtual environment image seen from the virtual observation point based on the saved history information.

2. The image generating method of claim 1, further comprising the following steps:
(6) a step of generating image of the moving body itself seen from the virtual observation point based parameter of the moving body itself.
(7) a step of generating a composite image including the image of the moving body itself and the virtual environment image, using the virtual environment image and the image of the moving body itself.

3. The generating method of claim 1, wherein the environment image is a plurality of still pictures.

4. The generating method of claim 1, wherein the environment image is moving picture.

5. The generating method of claim 2, wherein the parameter of the moving body itself in step (6) is for “any time point between a time point when a virtual observation point is designated, or close to that time point, to a time point when a generated composite image is presented”.

6. The generating method of claim 1, wherein the moving body can propel itself.

7. The generating method of claim 1, wherein the virtual observation point exists at a position looking at the environment around the moving body and/or the environment around a point the operator wants to see.

8. The generating method of claim 1, wherein the virtual observation point exists at a position looking at the moving body from behind.

9. The generating method of claim 1, wherein the “parameter of the space measurement sensor itself” in step (2) includes “position and attitude of space measurement sensor itself” and/or “data, matrix or table representing a relationship between data space acquired by the space sensor itself and real space”.

10. The generating method of claim 1, wherein “generating based on history information” in step (5) is “selection of any image contained in the environmental information based on closeness of position of the space measurement sensor itself at the time the environmental information is acquired, and the virtual observation point”.

11. The generating method of claim 1, wherein the “generation based on history information” in step (5) is “new generation based on history information”.

12. The generating method of claim 1, herein the virtual environment image is still picture.

13. The generating method of any one of claim 2, wherein the image of the moving body itself contained in the composite image of step (7) is a semi-transparent image, a transparent image, or a wireframe image.

14. The generating method of any one of claim 2, wherein position of the moving body is included in the parameter of the moving body itself.

15. The generating method of claim 14, wherein attitude of the moving body is further included in the parameter of the moving body itself.

16. A presentation method for presenting a composite image generated using any one of the methods of claim 2.

17. An image generating system, comprising a moving body, a control section and an information acquisition section, the moving body being provided with space measurement sensor for acquiring environment information, wherein the control section carries out the following functions:
(a) a function of saving history information representing the environmental information, the time when the environmental information was acquired, and parameter of the space measurement sensor it self at the time the environmental information was acquired;
(b) a function of receiving information for designated virtual observation point; and
(c) a function of generating virtual environment image seen from the virtual observation point based on the saved history information.

18. The image generating system of claim 17, further comprising an information acquisition section, the information acquisition section being for acquiring parameters of the moving body itself, wherein the control section further carries out the following functions:
(d) a function of generating image of the moving body itself seen from the virtual observation point based on parameter of the moving body itself;
(e) a function of generating a composite image including an image of the moving body and the virtual environment image, using the virtual environment image and the image of the moving body itself.

19. A computer program for causing a computer to execute the steps of the methods of claim 1.

20. A computer program for causing a computer to execute the function of the control section of claim 17.

21. Data containing information representing the virtual environment image or the composite image generated using the generating methods of claim 1.

22. A storage medium for storing the data of claim 21.
